(19) United States
(12) Patent Application Publication
(10) Pub. No.: US 2024/0421677 A1
(43) Pub. Date: Dec. 19, 2024

(54) TWISTING ASSEMBLY FOR WIRES OF INDUCTIVE WINDINGS AND THE LIKE

(71) Applicant: ATOP S.P.A., Barberino (IT)

(72) Inventors: Giovanni MANUELLI, Bagno a Ripoli (IT); Filippo PROFETI, Poggibonsi (IT)

(21) Appl. No.: 18/698,484

(22) PCT Filed: Sep. 27, 2022
(86) PCT No.: PCT/EP2022/076859

§ 371 Date: Apr. 4, 2024

(30) Foreign Application Priority Data
Oct. 14, 2021 (IT) 102021000026312

(51) Int. Cl. H02K 15/04; H02K 15/06

(52) U.S. Cl. CPC H02K 15/0428; H02K 15/064

(57) ABSTRACT

A twisting assembly for wires of inductive windings that comprises a fixed frame. The assembly comprises: at least two bushings provided with respective channels and each of which defines at least one seat for at least one respective wire; at least one upper shaped portion which is provided, on at least one upper surface of at least one bushing, with a conveyance chute for the terminal front of at least one wire; at least one element for moving the at least two bushings for the rotation of at least one first bushing with respect to at least one second bushing for the temporary alignment of at least one upper shaped portion of at least one first bushing with at least one channel of at least one second bushing which is open toward the first bushing.

The present invention relates to a twisting assembly for wires of inductive windings.

Electric motors, dynamos, alternators and transformers comprise a core of ferromagnetic material on which windings are arranged which are made with electrical wires arranged according to a specific geometry. The circulation of a current in at least one of the windings determines, by electromagnetic induction, the circulation of an induced current in at least one other winding. Furthermore, forces between the windings and the respective ferromagnetic cores act on each other and are capable, for example, of turning the rotor with respect to the stator in an electric motor.

Inductive windings are made with elements made of electrically conducting material (generally copper) which are covered with a layer of dielectric material (not electrically conducting), for their insulation. For specific applications, providing the windings is done using pieces (of any shape) of electrically conducting material coupled to each other at at least one end, which are inserted into the specific recesses present in the ferromagnetic cores of the machine under construction. These pieces are known as “hairpins” in the trade and they require, before their insertion into the respective recesses, preparatory operations for spatial orientation according to the desired winding logic. In particular, a first end of each piece is designed to be inserted into a respective first recess, while a second end of the piece needs to be inserted into a second recess, according to the desired logic for the winding being provided.

In order to accelerate the procedure of providing the windings, the possibility is known of shaping the wires, which constitute the various windings, before their insertion into the respective recesses of the ferromagnetic cores for which they are provided, so that they already assume the desired shape and arrangement.

This procedure requires the intervention of operators, who manually perform some positionings and who shape and orient the wires in the most appropriate manner. Obviously, this results in very high costs and implies a high risk of inaccuracies and human errors in the arrangement and shaping of the wires.

The aim of the present invention is to solve the above-mentioned drawbacks, by providing a twisting assembly for wires of inductive windings that enables the rapid advance preparation of at least some of an inductive winding.

Within this aim, an object of the invention is to provide a twisting assembly for wires of inductive windings of the completely automatic type.

Another object of the invention is to provide a twisting assembly for wires of inductive windings that does not subject the wires to excessive mechanical stresses.

Another object of the invention is to provide a twisting assembly for wires of inductive windings that is particularly precise and assured.

Another object of the invention is to provide a twisting assembly for wires of inductive windings that ensures the maximum consistency of the twisting performed, in geometric and also aesthetic terms.

Another object of the present invention is to provide a twisting assembly for wires of inductive windings that is low cost, easily and practically implemented and safe in use.

This aim and these objects are achieved by a twisting assembly for wires of inductive windings of the type comprising a fixed frame on which a carousel provided with at least one pair of seats for respective wires of different lengths can rotate, as defined in claim 1

The above aim and objects are also achieved by a method for twisting wires of inductive windings as defined in claim 10

Further characteristics and advantages of the invention will become better apparent from the detailed description that follows of a preferred, but not exclusive, embodiment of the twisting assembly for wires of inductive windings, which is illustrated by way of non-limiting example in the accompanying drawings wherein:

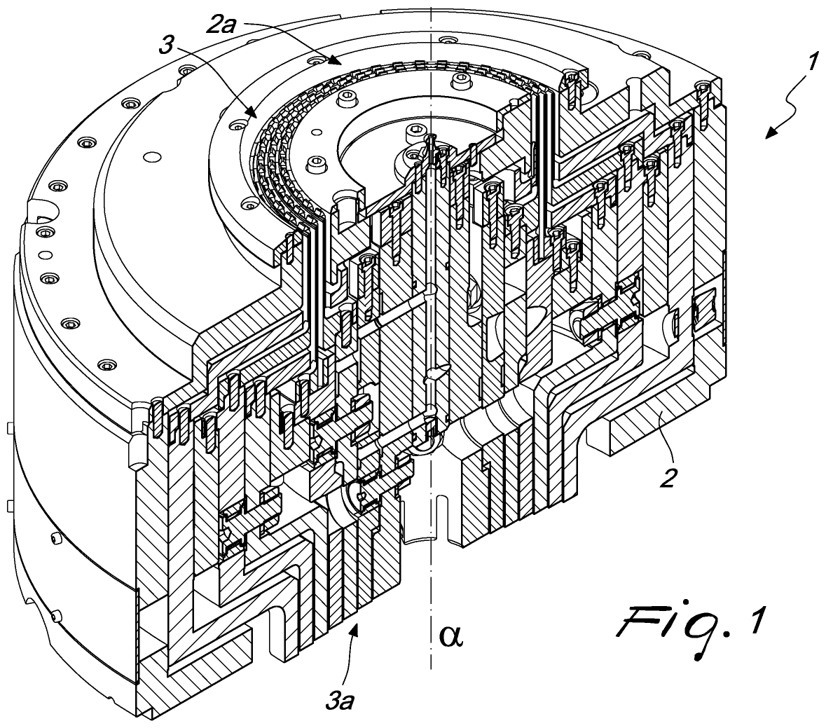

FIG. 1 is a schematic perspective view in cross-section, taken along a transverse plane, of a possible embodiment of a twisting assembly for wires of inductive windings according to the invention;

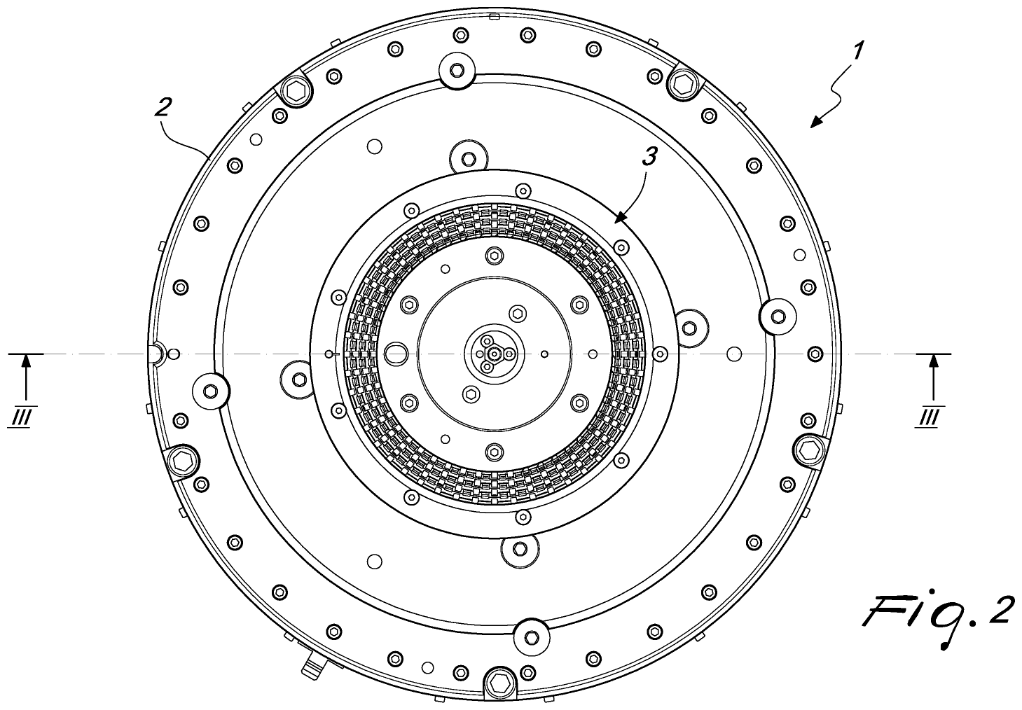

FIG. 2 is a schematic view from above of the assembly of FIG. 1 in a first configuration;

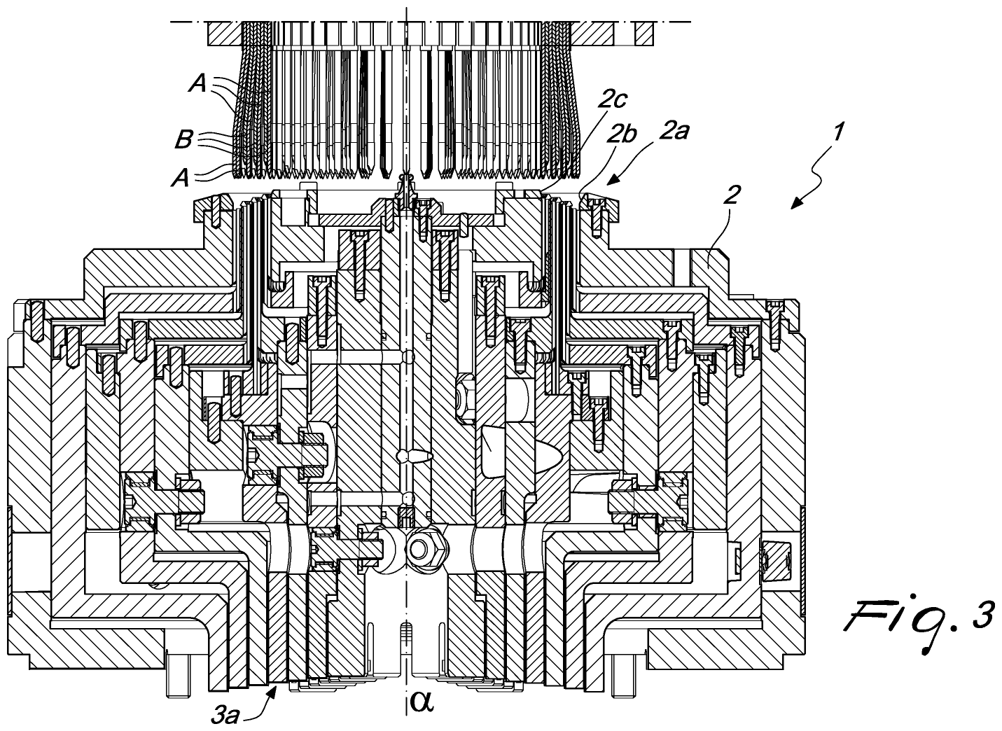

FIG. 3 is a cross-sectional view taken along the line III-III traced in

FIG. 2;

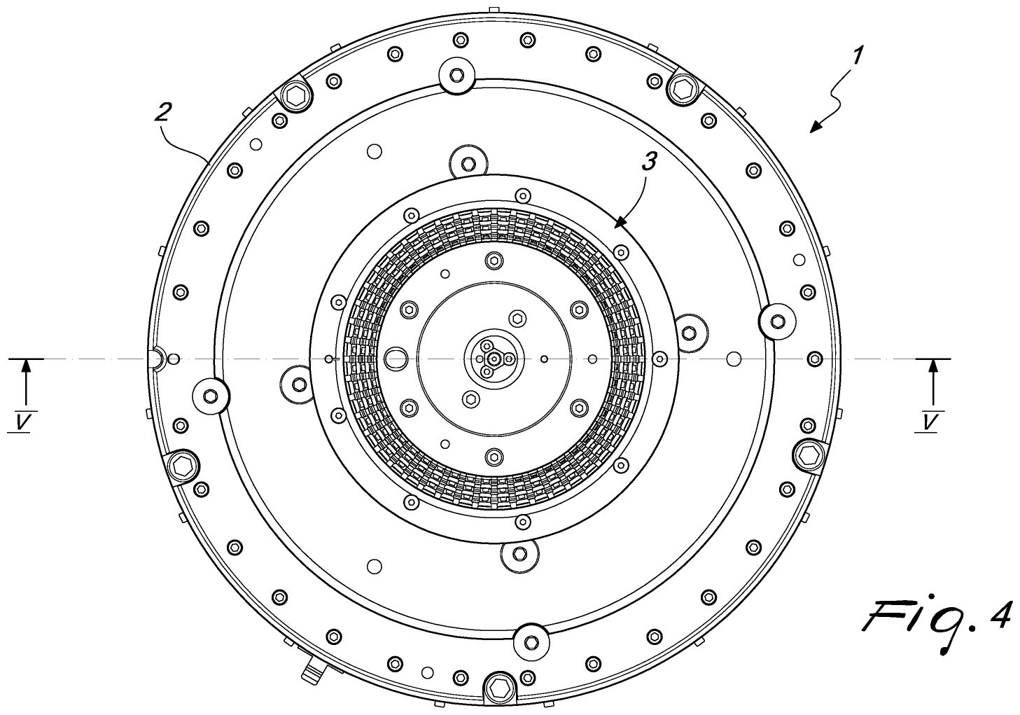

FIG. 4 is a schematic view from above of the assembly of FIG. 1 in a second configuration;

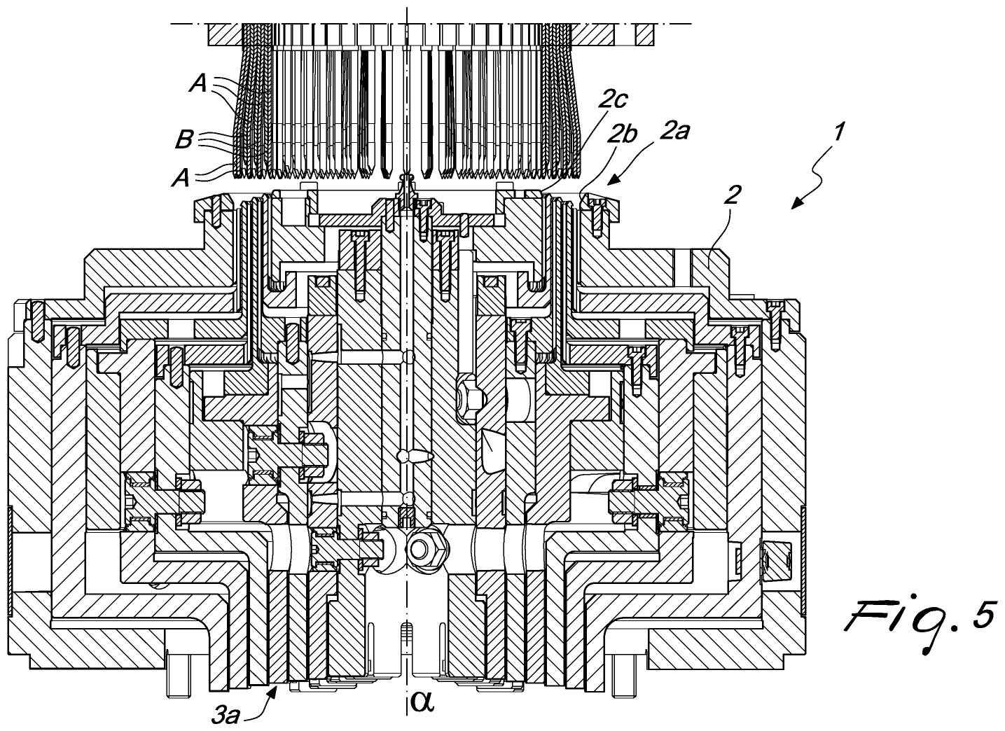

FIG. 5 is a cross-sectional view taken along the line V-V traced in FIG. 4;

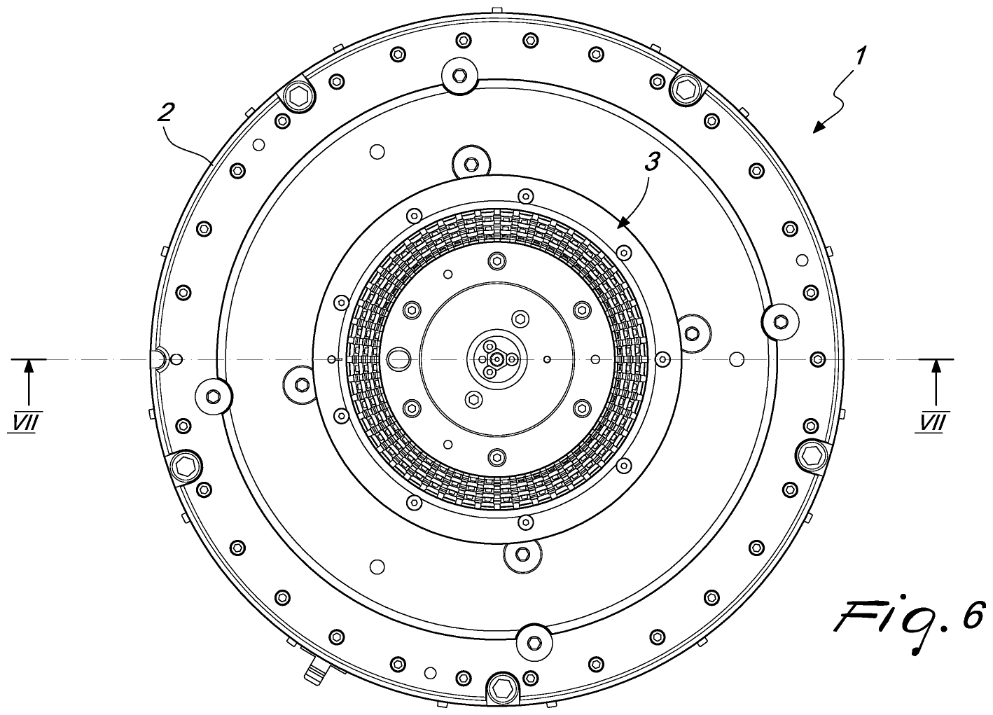

FIG. 6 is a schematic view from above of the assembly of FIG. 1 in a third configuration;

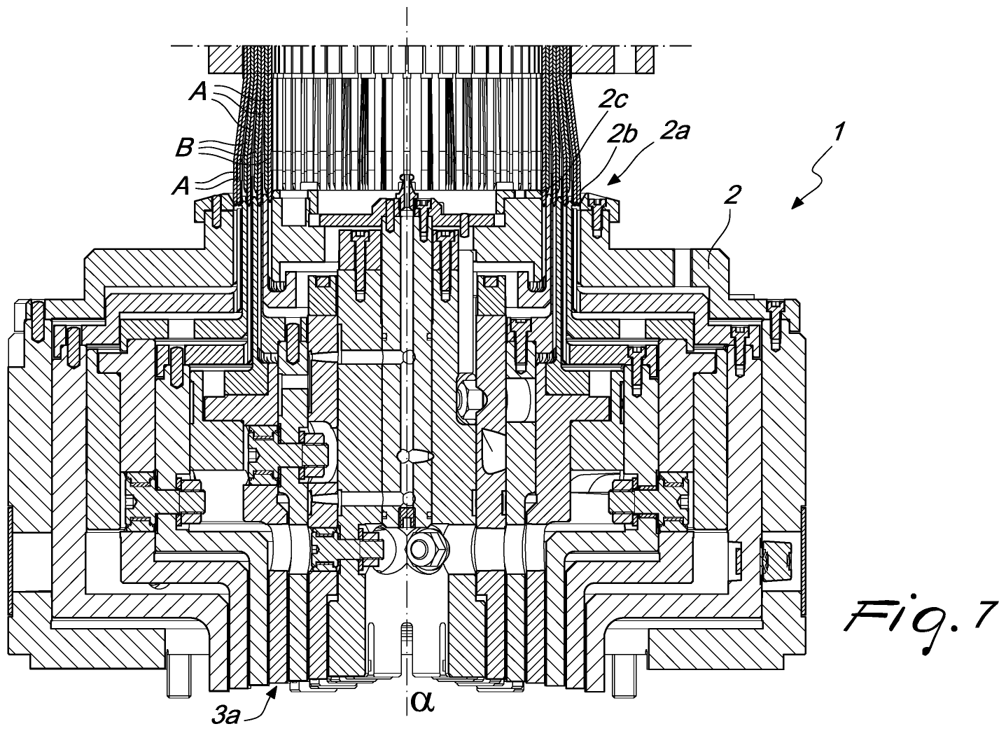

FIG. 7 is a cross-sectional view taken along the line VII-VII traced in FIG. 6;

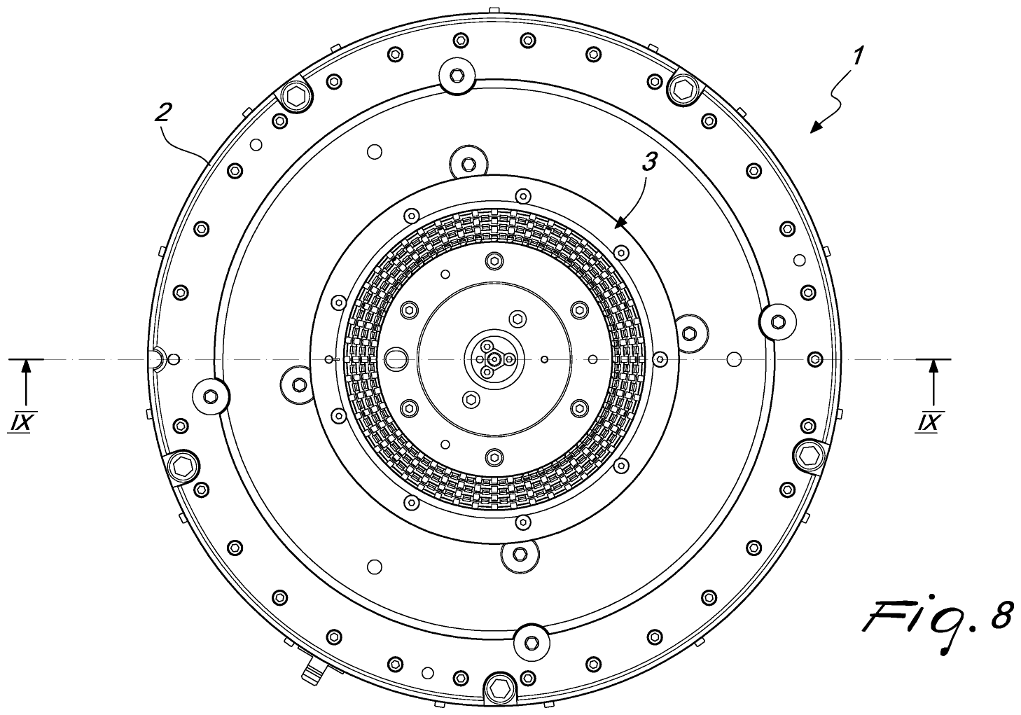

FIG. 8 is a schematic view from above of the assembly of FIG. 1 in a fourth configuration;

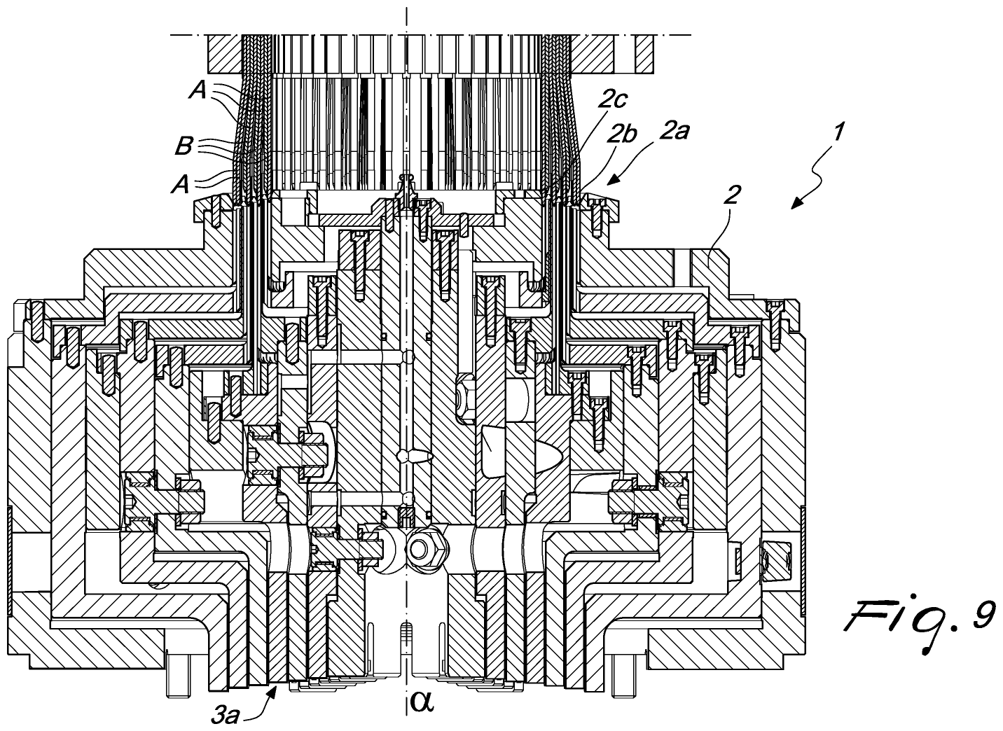

FIG. 9 is a cross-sectional view taken along the line IX-IX traced in FIG. 8;

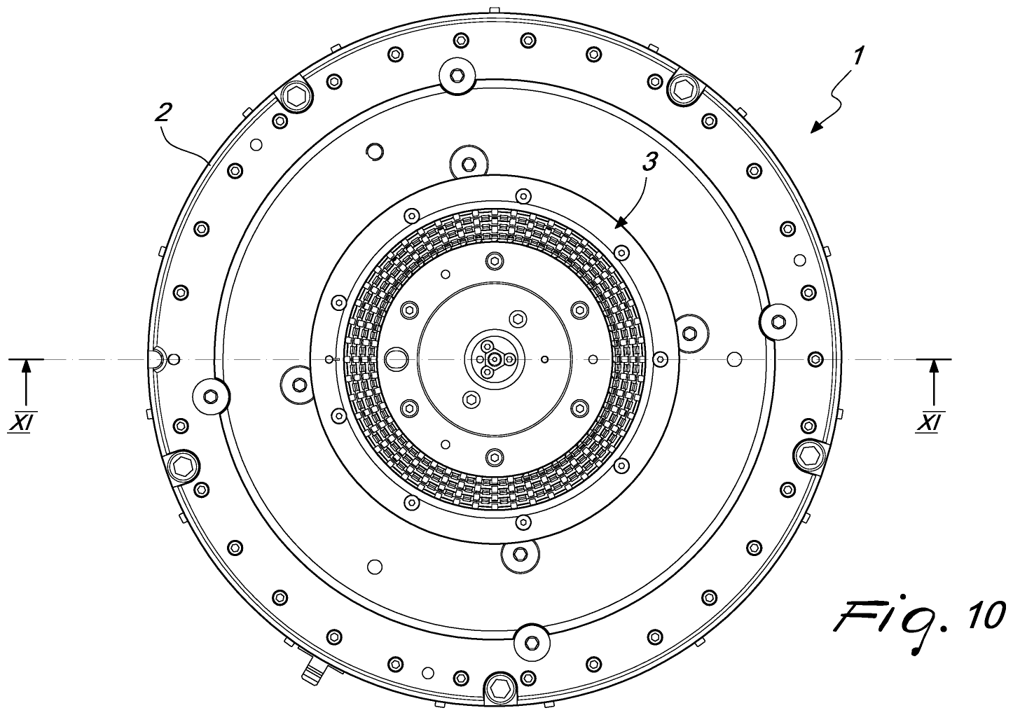

FIG. 10 is a schematic view from above of the assembly of FIG. 1 in a fifth configuration;

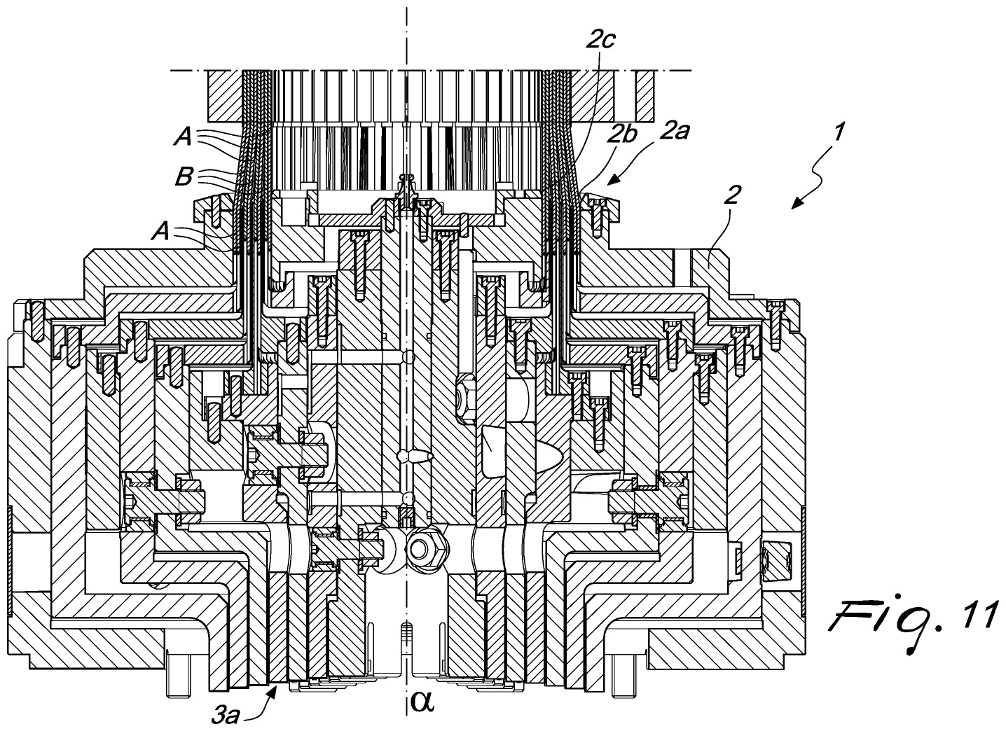

FIG. 11 is a cross-sectional view taken along the line XI-XI traced in FIG. 10;

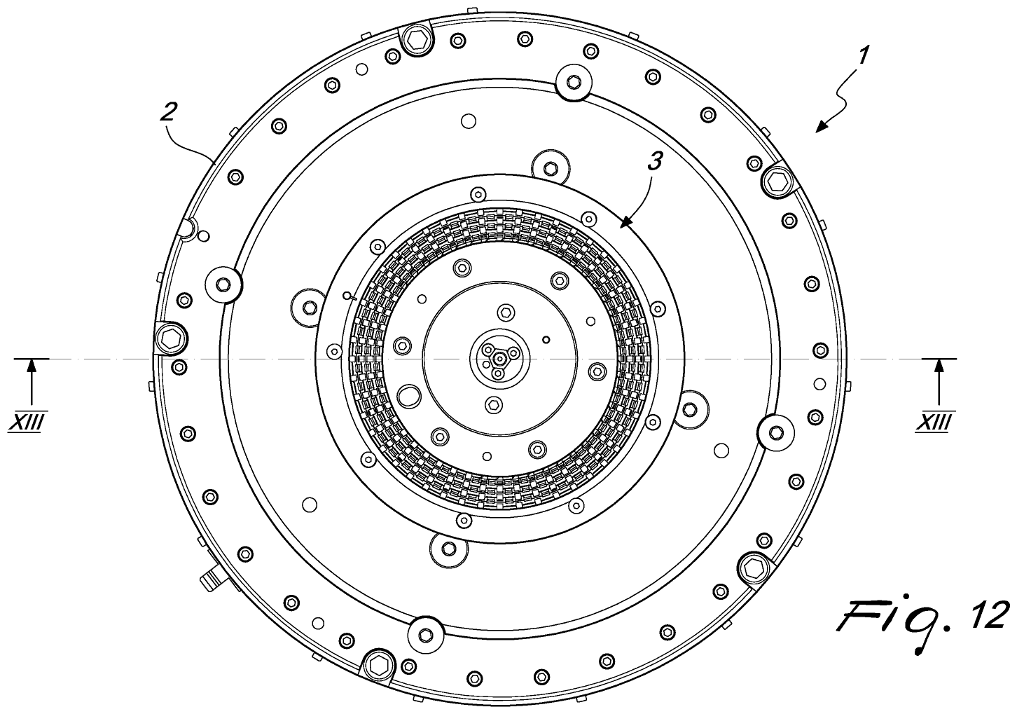

FIG. 12 is a schematic view from above of the assembly of FIG. 1 in a sixth configuration;

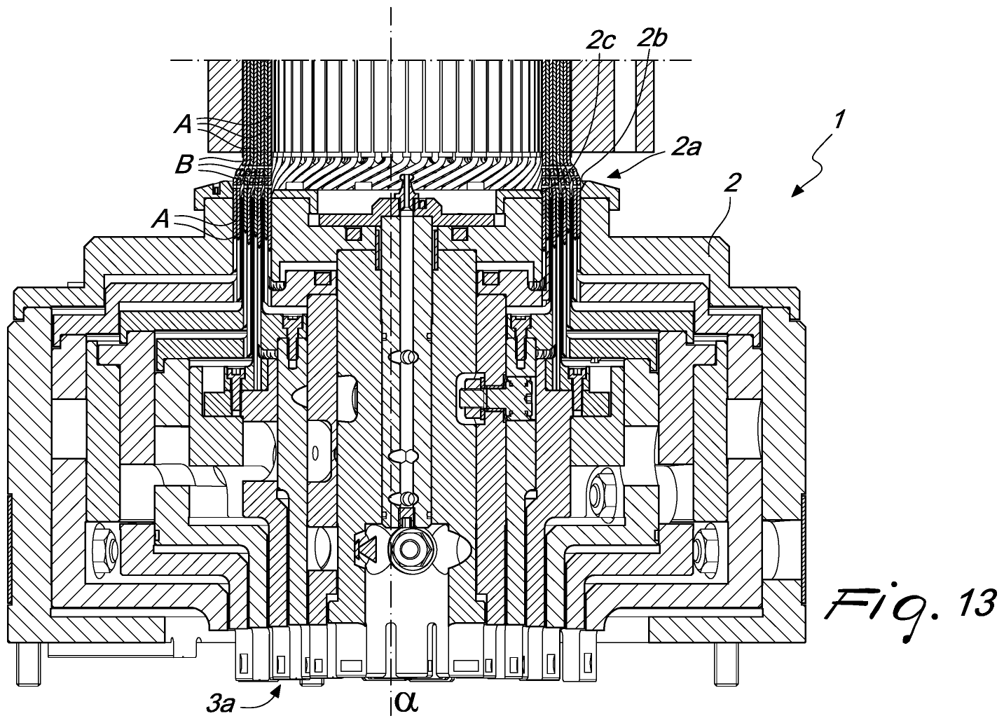

FIG. 13 is a cross-sectional view taken along the line XIII-XIII traced in FIG. 12;

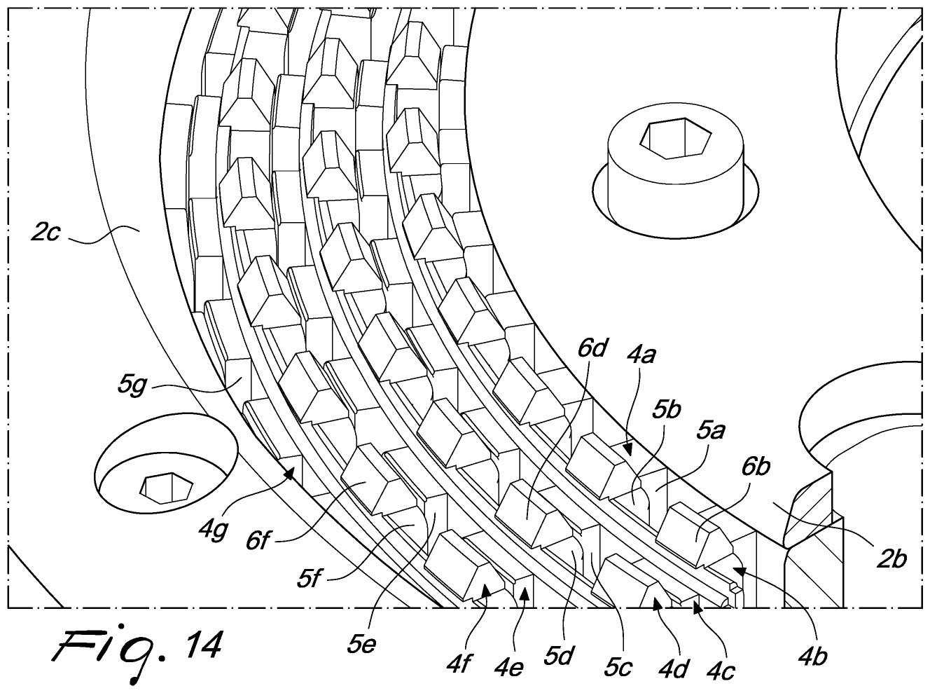

FIG. 14 is an enlarged view of a detail of FIG. 1;

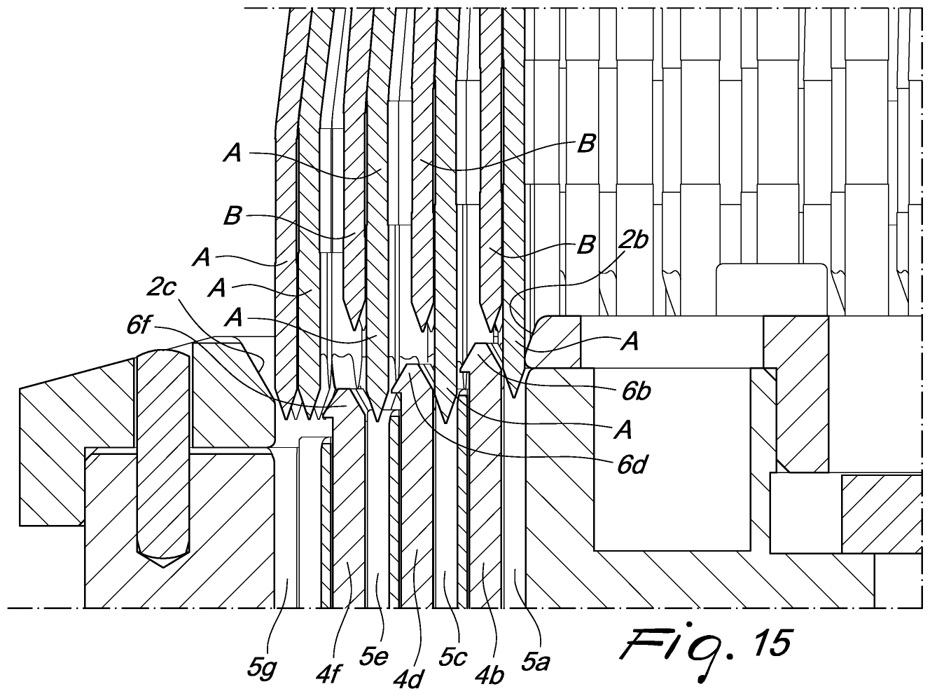

FIG. 15 is an enlarged view of a detail of FIG. 7;

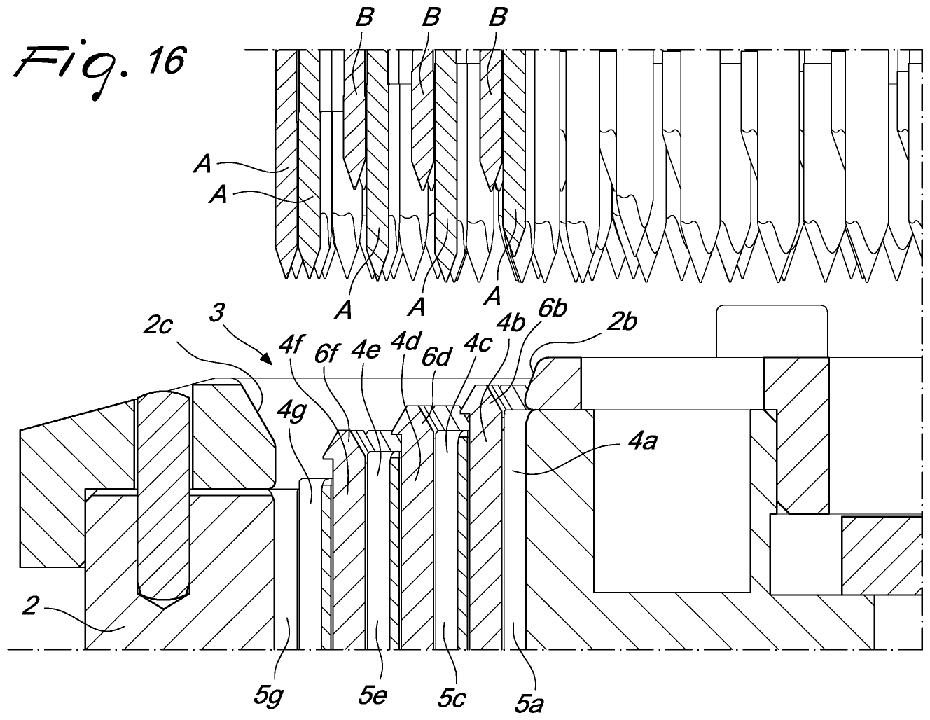

FIG. 16 is an enlarged view of a detail of FIG. 5.

With particular reference to the figures, the reference numeral 1 generally designates a twisting assembly for wires A, B of inductive windings.

In the present description, the term “inductive windings” includes the windings of electric machines (for example the stator or rotor winding of an electric motor or the windings of a transformer) or other electrical windings designed to establish an inductive coupling with other windings or other components.

The twisting assembly 1 comprises a fixed frame 2 on which a carousel 3 provided with at least one pair of seats for respective wires A, B can rotate.

According to the invention the twisting assembly 1 comprises at least two bushings 4a, 4b, 4c, 4d, 4e, 4f, 4g, which are circular in cross-section and are mutually concentric.

Each one of such bushings 4a, 4b, 4c, 4d, 4e, 4f, 4g is provided with respective channels 5a, 5b, 5c, 5d, 5e, 5f, 5g which are substantially parallel to the axis of symmetry a and each of which defines at least one seat for at least one respective wire A, B.

The channels 5a, 5b, 5c, 5d, 5e, 5f, 5g are shaped substantially like outwardly-open pockets defined on the cylindrical surface of the respective bushing 4a, 4b, 4c, 4d, 4e, 4f, 4g: in practice they are perimetric longitudinal grooves. When two channels 5a, 5b, 5c, 5d, 5e, 5f, 5g face each other, they delimit a receptacle that is adapted to accommodate two wires A, B that are laterally adjacent and proximate.

At least one of the cited bushings 4a, 4b, 4c, 4d, 4e, 4f, 4g comprises along its upper edge at least one upper shaped portion 6b, 6d, of which has, on at least one surface thereof, a conveyance chute for the terminal front of at least one wire A into a seat that is proximate thereto.

The at least one upper shaped portion 6 can be constituted by a localized projection (for example a tooth) or by a continuous ridge (with conveniently shaped surfaces) that is broken solely at the channels 5b, 5d, 5f of the respective bushing 4b, 4d, 4f.

In any case other, different embodiments are not ruled out.

According to the invention the assembly 1 will further comprise at least one element 3a for moving the at least two bushings 4a, 4b, 4c, 4d, 4e, 4f, 4g for the rotation of at least one first bushing 4b, 4d, 4f with respect to at least one second bushing 4a, 4c, 4e, 4g (the reference numerals to the components given in the accompanying figures represent one of the possible embodiments proposed by way of non-limiting example of the present invention).

It should be noted that the rotation of the at least one first bushing 4b, 4d, 4f with respect to at least one second bushing 4a, 4c, 4e, 4g will be adapted for the temporary alignment of at least one upper shaped portion 6b, 6d, 6f of at least one first bushing 4b, 4d, 4f with at least one channel 5a, 5c, 5e, 5g of at least one second bushing 4a, 4c, 4e, 4g (in particular the at least one channel 5a, 5c, 5e, 5g will have the respective opening directed toward the at least one first bushing 4b, 4d, 4f which has the upper shaped portion 6b, 6d, 6f).

It should be noted that, with particular reference to an embodiment of undoubted practical and applicative interest, the bushings 4a, 4b, 4c, 4d, 4e, 4f, 4g can advantageously be a plurality: each channel 5a, 5b, 5c, 5d, 5e, 5f, 5g of each bushing 4a, 4b, 4c, 4d, 4e, 4f, 4g will therefore be conveniently capable of being aligned with a corresponding channel 5a, 5b, 5c, 5d, 5e, 5f, 5g of every other bushing 4a, 4b, 4c, 4d, 4e, 4f, 4g along a radial direction. The channels 5a, 5b, 5c, 5d, 5e, 5f, 5g, when they are aligned in pairs, will have the openings facing each other and proximate, thus defining a receptacle adapted to accommodate at least a wire A and a wire B.

It should furthermore be noted that each channel 5a, 5b, 5c, 5d, 5e, 5f, 5g of each bushing 4a, 4b, 4c, 4d, 4e, 4f, 4g can profitably comprise an end inlet with flared edges in order to facilitate the ingress of the terminal front of at least one wire A, B: the presence of flaring of the front end of each channel 5a, 5b, 5c, 5d, 5e, 5f, 5g ensures that the terminal front of the wire A, B, when it comes into contact with such inclined surface, is conveyed toward the inside of the channel 5a, 5b, 5c, 5d, 5e, 5f, 5g, thus compensating for any problems resulting from misalignments and/or dimensional irregularities.

The term “flaring” should be understood to include bevels, connections and, in general, all inclined surfaces that are designed to connect the upper edge of the bushing 4a, 4b, 4c, 4d, 4e, 4f, 4g with the walls of the respective channel 5a, 5b, 5c, 5d, 5e, 5f, 5g.

It should be noted that the element 3a for the movement of the bushings 4a, 4b, 4c, 4d, 4e, 4f, 4g is of the combined rotary and translational type and therefore also permits the movement of such bushings 4a, 4b, 4c, 4d, 4e, 4f, 4g between an inactive configuration in which at least one bushing 4b, 4d, 4f, arranged externally in a radial direction, is located at a different height with respect to the at least one bushing 4a, 4c, 4e that is arranged inside it, and a configuration of full twisting of wires A, B accommodated in the channels 5a, 5b, 5c, 5d, 5e, 5f, 5g in which the bushings 4a, 4b, 4c, 4d, 4e, 4f, 4g are substantially arranged all at a same height, being substantially coplanar, for the arrangement of the wires A, B according to the geometry of the desired inductive winding.

By virtue of the specific inactive configuration, which entails different heights of the bushings 4a, 4b, 4c, 4d, 4e, 4f, 4g, the operations to insert (substantially straight) wires A, B into the channels 5a, 5b, 5c, 5d, 5e, 5f, 5g until they are fully accommodated are made easier.

With particular reference to an embodiment of undoubted practical and applicative interest, the axial height of a first bushing 4a, 4c, 4e will advantageously be greater than that of a second bushing 4b, 4d, 4f that is contiguous to it and which has, with respect to such first bushing 4a, 4c, 4e, a greater diameter. This difference in height enables the non-simultaneous insertion of the wires A, B and therefore a simpler management of their insertion.

The configuration of full twisting of the wires A, B accommodated in the channels 5a, 5b, 5c, 5d, 5e, 5f, 5g will instead ensure that, since the bushings 4a, 4b, 4c, 4d, 4e, 4f, 4g will in this case be arranged at a same height, the wires A, B will be perfectly arranged according to the geometry of the provided inductive winding.

It should therefore be noted that, by virtue of the presence of the element 3a of the combined rotary and translational type for the movement of the bushings 4a, 4b, 4c, 4d, 4e, 4f, 4g, between each bushing 4a, 4b, 4c, 4d, 4e, 4f, 4g and fixed frame 2, guiding means 2a can usefully be interposed for that bushing 4a, 4b, 4c, 4d, 4e, 4f, 4g (in particular, the portion of fixed frame 2 with respect to the specific bushing 4a, 4b, 4c, 4d, 4e, 4f, 4g is guided in its motion).

Such guiding means 2a conveniently will define, for the bushing 4a, 4b, 4c, 4d, 4e, 4f, 4g, a degree of rotational freedom about its own axis of symmetry a and a degree of translational freedom along the direction of its own axis of symmetry a: such movements of rotation and translation (in height) will occur according to angular and linear travels of predefined extent (as a function of the specific reciprocal movements to be imparted to the various bushings 4a, 4b, 4c, 4d, 4e, 4f, 4g for the purpose of carrying out a twisting of the wires A, B corresponding to the geometric characteristics of the specific inductive winding that it is desired to provide).

In order to ensure an optimal operation of the assembly 1 according to the invention, the at least one upper shaped portion 6b, 6d, 6f can advantageously be shaped substantially like a wedge, comprising a pair of mutually opposite inclined faces, which substantially converge at the apex of the wedge. In this manner it can act as inclined guide plane for a wire A, B that needs to be routed into a channel 5a, 5c, 5e, 5g of a bushing 4a, 4c 4e, 4g that is contiguous with the one that comprises this upper shaped portion 6b, 6d, 6f (arranged inside or outside the bushing 4b, 4d, 4f that comprises the upper shaped portion 6b, 6d, 6f).

It should be noted that, in such case, each inclined face of the wedge that constitutes the upper shaped portion 6b, 6d, 6f will profitably define a conveyance chute for the terminal front of at least one such wire A, B into a seat of a contiguous bushing 4a, 4c, 4e, 4g (which has the respective opening directed toward that inclined face).

The assembly 1 according to the invention further comprises an internal flared surface 2b which contiguously faces the innermost first bushing 4a and an external flared surface 2c which contiguously faces the outermost first bushing 4g, each flared surface 2b, 2c being configured to route a terminal end of at least one wire A, B into the first channels 5a, 5g of the bushings 4a, 4g.

Such flared surfaces 2b, 2c are fixed to the fixed frame 2.

The present invention also aims to protect a method for twisting wires A, B of inductive windings by means of a twisting assembly 1 of the type described up to this point.

Such method entails a first step during which it will be necessary to prepare the wires A, B in pairs, according to the predefined geometric criteria of the inductive winding to be provided, keeping, in each pair, one wire A protruding more than the other B. This first step is defined purely by way of example by the accompanying FIGS. 2 and 3.

Subsequently, during a second step, it will be necessary to subject at least one first bushing 4b, 4d, 4f of the assembly 1 to a first rotation, thus obtaining the alignment of at least one upper shaped portion 6b, 6d, 6f thereof with at least one channel 5a, 5c, 5e, 5g of an additional second bushing 4a, 4c, 4e, 4g which is contiguous thereto. This second step is defined purely by way of example by the accompanying FIGS. 4 and 5.

Then (during a third step) each pair of wires A, B can be moved closer to the top of the assembly 1, until the terminal end of the most protruding wire A is inserted into a respective channel 5a, 5c, 5e, 5g of such additional second bushing 4a, 4c, 4e, 4g: during the insertion, the end of the wire A will be guided by the upper shaped portion 6b, 6d, 6f of the at least one first bushing 4b, 4d, 4f. This third step is defined purely by way of example by the accompanying FIGS. 6, 7 and 15.

The method then entails a fourth step in which the at least one first bushing 4b, 4d, 4f of the assembly 1 is subjected to a second rotation (which may also optionally be retrograde), thus obtaining the alignment of the respective channel 5b, 5d, 5f with that of the additional second bushing 4a, 4c, 4e, 4g which contains the terminal end of the most protruding wire A. This fourth step is defined purely by way of example by the accompanying FIGS. 8 and 9.

The fifth step of the method entails moving each pair of wires A, B closer again to the top of the assembly 1 until the terminal end of the shorter wire B is inserted into the channel 5b, 5d, 5f of the first bushing 4b, 4d, 4f that is contiguous to that of the additional second bushing 4a, 4c, 4e, 4g that already contains the terminal end of the most protruding wire A. This fifth step is defined purely by way of example by the accompanying FIGS. 10 and 11.

The insertion of the wires A, B into the channels 5a, 5b, 5c, 5d, 5e, 5f, 5g can then hen be completed (in a seventh step).

The seventh and final step of the method entails subjecting at least one of the bushings 4a, 4b, 4c, 4d, 4e, 4f, 4g to rotation for the twisting of at least one of the wires A, B according to the pattern specified for the inductive winding to be provided. This seventh_step is defined purely by way of example by the accompanying FIGS. 12 and 13.

It should be noted that the method according to the invention can also comprise a preliminary step of mutual alignment along a radial direction of all the channels 5a, 5b, 5c, 5d, 5e, 5f, 5g of the bushings 4a, 4b, 4c, 4d, 4e, 4f, 4g which define the seats for the wires A, B.

It should furthermore be noted that the first bushings 4b, 4d, 4f can advantageously be a plurality (for example 3 in the accompanying figures, although embodiments of the assembly with a different number of these components are not ruled out): each first bushing 4b, 4d, 4f will be contiguous with at least one respective second bushing 4a, 4c, 4e, 4g which is coaxial thereto and is arranged in a configuration chosen from internal and external.

The assembly 1 is particularly useful as it makes possible to provide (during the second step of the method) a configuration thereof in which the insertion of the terminal front of the (longer) conducting wires A inside the respective channel 5a, 5c, 5e, 5g of the bushing 4a, 4c, 4e, 4g that they face toward, is facilitated: in fact the arrangement of the upper shaped portion 6b, 6d, 6f of the at least one first bushing 4b, 4d, 4f that is aligned with the channels 5a, 5c, 5e, 5g of the bushings 4a, 4c, 4e, 4g that are contiguous therewith ensures that the terminal front of the wire A is guided toward the inlet of the respective channel 5a, 5c, 5e, 5g (the terminal front gains entry to the inlet by sliding on the inclined surfaces of the upper shaped portion 6b, 6d, 6f, as if it were an inclined plane). The flaring present at the inlet of each channel 5a, 5c, 5e, 5g will then ensure that the terminal front of the wire A will be correctly inserted inside it.

By executing the rotation (optionally retrograde) in step 3 of the method, an alignment will be generated of the channels 5b, 5d, 5f with the channels 5a, 5c, 5e, 5g which already contain a respective wire A: during the step of alignment of these channels (5b, 5d, 5f aligned with 5a, 5c, 5e, 5g) the openings of all the channels 5a, 5b, 5c, 5d, 5e, 5f, 5g will be facing each other and mutually proximate.

During the fourth step the terminal front of the wire B will be inserted into the respective channel 5b, 5d, 5f and this will be facilitated by the presence of wires A in the channels 5a, 5c, 5e, 5g, which will act as guides for the wires B, routing them toward the inlet of the respective channel 5b, 5d, 5f (which are also provided with upper flared regions for the routing of the respective wire B).

By virtue of the fact that the channels 5a, 5b, 5c, 5d, 5e, 5f, 5g are open on one side thereof, the wire A that is already present in the channel 5a, 5c, 5e, 5g will act as a guide element for the wire B, thus facilitating the operation to insert it.

The subsequent steps of the method occur intuitively, in that when the wires A, B are completely inserted into the respective channels 5a, 5b, 5c, 5d, 5e, 5f, 5g of the bushings 4a, 4b, 4c, 4d, 4e, 4f, 4g, the rotation (which will occur according to specific predefined laws of motion that depend on the type of inductive winding to be provided) will determine a twisting of the wires A, B corresponding to the geometric requirements of the inductive winding to be provided.

It should be noted that the wires A, B can preferably be constituted by “hairpins” or other thin conductor elements (coated with a layer of dielectric material) that are adapted to the provision of inductive windings.

Advantageously the present invention solves the above-mentioned problems, by providing a twisting assembly 1 for wires A, B of inductive windings that enables the rapid advance preparation of at least some of an inductive winding.

Conveniently, the twisting assembly 1 according to the invention can be completely automatic.

Profitably, the twisting assembly 1 according to the invention does not subject the wires A, B to excessive mechanical stresses, by virtue of the variations in height of the bushings 4a, 4b, 4c, 4d, 4e, 4f, 4g which make it possible to compensate the variations in length (in the vertical/axial direction) of the wires A, B that are induced by the twisting thereof.

Advantageously, the twisting assembly 1 according to the invention is particularly precise and assured.

Positively, the twisting assembly 1 according to the invention ensures the maximum consistency of the twisting performed, in geometric and also aesthetic terms.

Positively, the present invention defines a twisting assembly 1 for wires A, B of inductive windings that is easily and practically implemented and of low cost: such characteristics make the assembly 1 and the method for twisting according to the invention innovations that are safe in use.

The invention thus conceived is susceptible of numerous modifications and variations, all of which are within the scope of the appended claims. Moreover, all the details may be substituted by other, technically equivalent elements.

In the embodiments illustrated, individual characteristics shown in relation to specific examples may in reality be interchanged with other, different characteristics, existing in other embodiments.

In practice, the materials employed, as well as the dimensions, may be any according to requirements and to the state of the art.

The disclosures in Italian Patent Application No. 102021000026312 from which this application claims priority are incorporated herein by reference.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1-14. (canceled)

15. A twisting assembly for wires of inductive windings of the type comprising:
a fixed frame on which a carousel, having an axis of symmetry and having seats for respective wires of different lengths, is configured to rotate,
at least one first and one second bushing, which are cylindrical, mutually concentric, contiguous, and provided with respective first and second channels which are substantially parallel to the axis of symmetry and which define respective first and second seats for respective wires, said first and second seats being open on a side directed toward a contiguous bushing; said assembly comprising:
shaped portions, each one provided, on an upper surface of the second bushing, with a conveyance chute configured to route a terminal end of at least one wire into said first channels of the first bushing that is contiguous with the second bushing that is provided with the shaped portions;
at least one element for moving said at least one first and second bushing for a mutual rotation between the first and the second bushing, said mutual rotation being configured for a temporary alignment of said shaped portions of the second bushing with the first channels of the first bushing that is contiguous with the second bushing that is provided with the shaped portions.

16. The twisting assembly according to claim 15, wherein said first channels and second channels have respective openings facing each other and which are mutually proximate.

17. The twisting assembly according to claim 15, wherein each channel of the first and second channels of each bushing of the first and second bushings comprises an end inlet, with flared edges in order to facilitate entry of a terminal front of at least one wire.

18. The twisting assembly according to claim 15, wherein said element for the movement of said first and second bushings is of a combined rotary and translational type for a movement of said first and second bushings between an inactive configuration, in which at least one bushing arranged externally in a radial direction is located at a different height with respect to the at least one bushing that is arranged inside it, for an accommodation of substantially straight wires in the respective channels, and a configuration of full twisting of wires accommodated in said first and second channels, said first and second bushings being arranged at a same height, being substantially coplanar, for an arrangement of the said wires according to a geometry of a desired inductive winding.

19. The twisting assembly according to claim 18, wherein between each bushing and said fixed frame guiding means for said bushing are interposed, said guiding means defining for said bushing a degree of rotational freedom about an axis of symmetry thereof and a degree of translational freedom along a direction of said axis of symmetry, according to angular and linear travels of predefined extent.

20. The twisting assembly according to claim 15, wherein at least one of said shaped portion is shaped substantially like a wedge and comprises a pair of mutually opposite inclined faces which substantially converge upward at an apex of said wedge.

21. The twisting assembly according to claim 20, wherein each inclined face of said wedge defines said conveyance chute for the terminal end of said at least one wire into said channel of said first bushing which is contiguous and open toward an edge of said wedge.

22. The twisting assembly according to claim 21, further comprising an internal flared surface which contiguously faces an innermost first bushing and an external flared surface which contiguously faces an outermost first bushing, each flared surface being configured to route a terminal end of at least one wire into said first channels of said bushings.

23. The twisting assembly according to claim 22, wherein said flared surfaces are fixed to the fixed frame.

24. A method for twisting wires of inductive windings by means of a twisting assembly according to claim 15, which comprises the steps of:
preparing the wires in pairs according to a predefined geometric criteria of an inductive winding to be provided, keeping, in each pair, one wire protruding more than another;
subjecting at least one second bushing of said assembly to a first rotation, thus obtaining an alignment of at least one upper shaped portion thereof with at least one first channel of an additional first bushing which is contiguous thereto;
moving each said pair of wires closer to a top of said assembly until a terminal front of a most protruding wire is inserted into a respective first channel of said first bushing, guided by said upper shaped portion of said at least one second bushing;
subjecting the at least one second bushing of said assembly to a second rotation, thus obtaining an alignment of the respective second channel with that of an additional first bushing which contains the terminal front of the most protruding wire, so that the openings of the channels that are aligned are facing each other;
moving each said pair of wires closer again to the top of said assembly until the terminal front of the shorter wire is inserted into the second channel of said second bushing that is contiguous to that of the additional first bushing that already contains the terminal front of the wire most protruding;
completing the insertion of the wires into the channels;
subjecting at least one of said bushings to rotation for the twisting of at least one of the said wires according to the pattern specified for the inductive winding to be provided.

25. The method for twisting according to claim 24, wherein, at a same time as the rotation of the bushings for the twisting according to a specified pattern, said bushings are subjected to a preset translational movement along the direction of an axis of symmetry thereof in which an axial height of the innermost bushings is the same as or higher than a height of the next immediately outermost bushings.

26. The method for twisting according to claim 24, wherein the bushings will have a same axial height in a configuration of full twisting.

27. The method for twisting according to claim 24, further comprising a preliminary step of mutual alignment along a radial direction of all the said channels of said bushings which define said seats for said wires.

28. The method for twisting according to claim 24, wherein said second bushings are a plurality, each second bushing being contiguous with at least one respective first bushing which is coaxial thereto and is arranged in a configuration chosen from internal and external.
